(19) United States
(12) Patent Application Publication
(10) Pub. No.: US 2017/0210632 A1
(43) Pub. Date: Jul. 27, 2017

(54) METHODS AND SYSTEMS FOR PRODUCING AMMONIA

(71) Applicant: EMPIRE TECHNOLOGY DEVELOPMENT LLC, Wilmington, DE (US)

(72) Inventor: Arockiadoss THEVASAHAYAM, Madurai, Tamilnadu (IN)

(73) Assignee: EMPIRE TECHNOLOGY DEVELOPMENT LLC, Wilmington, DE (US)

(21) Appl. No.: 15/326,482

(22) PCT Filed: Jul. 14, 2015
(86) PCT No.: PCT/US15/40294

§ 371 Date: Jan. 14, 2017

(30) Foreign Application Priority Data
Jul. 14, 2014 (IN) 3476/CHE/2014

(51) Int. Cl. C01C 1/04; B01J 35/00; B01J 23/847; B01J 19/08; B01J 8/02

(52) U.S. Cl. CPC C01C 1/04; B01J 19/088; B01J 8/02; B01J 8/0285; B01J 23/8472; B01J 35/0033; B01J 2219/0854; B01J 2219/0875; B01J 2219/00029; B01J 2219/00033; B01J 2219/0871

(57) ABSTRACT

Disclosed herein are methods and systems to produce ammonia from nitrogen and water. In an embodiment, a method of producing ammonia involves contacting nitrogen, water, and at least one superparamagnetic catalyst to form a mixture, and exposing the mixture to a fluctuating magnetic field. In some embodiments, the superparamagnetic catalyst is BVO₂FeO₂.

### RELATED APPLICATION

This application claims priority to Indian Patent Application No. 3476/CHE/2014, filed Jul. 14, 2014, entitled, “Methods and Systems for Producing Ammonia,” the contents of which are herein incorporated by reference.

### BACKGROUND

Ammonia synthesis is an important industrial process. Ammonia is produced in huge quantities worldwide, for use in the fertilizer industry, as a precursor for nitric acid and nitrates for the explosives industry, and as a raw material for various industrial chemicals. The dominant ammonia production today is the energy intensive Haber-Bosch process invented in 1904 which requires high temperature (500° C.) and/or high pressure (150-300 bar). However, in practice, both high pressures and temperatures are used due to a sluggish reaction rate. Due to overall low reaction efficiency when hydrogen and nitrogen are first passed over the catalyst bed, most ammonia production plants utilize multiple adiabatically heated catalyst beds with cooling between beds, typically with axial or radial flow. These steps are not economical due to increased operational and capital costs. Thus, it is desirable to produce ammonia efficiently and economically.

### SUMMARY

Disclosed herein are methods and systems to produce ammonia from nitrogen and water. In an embodiment, a method of producing ammonia involves contacting nitrogen, water, and at least one superparamagnetic catalyst to form a mixture, and exposing the mixture to a fluctuating magnetic field.

In an additional embodiment, a method of preparing a catalyst involves contacting vanadium pentoxide with a first base to form a first reaction composition, contacting the first reaction composition with boric acid to form a second reaction composition, contacting the second reaction composition with a second base to form a third reaction composition, contacting the third reaction composition with a bidentate ligand to form a fourth reaction composition, and contacting the fourth reaction composition with Fe₂O₃ to form the catalyst. In some embodiments, the catalyst produced herein is a superparamagnetic catalyst.

In a further embodiment, a reactor system for producing ammonia from nitrogen includes a closed reaction vessel configured to receive nitrogen, water, and a superparamagnetic catalyst, and at least one current carrying element arranged in proximity to a surface of the reaction vessel and configured to provide a fluctuating magnetic field.

### BRIEF DESCRIPTION OF THE FIGURES

FIG. 1 depicts a diagram of a reactor system to produce ammonia from nitrogen and water according to an embodiment.

FIG. 2 represents a putative structure of BVO₂FeO₂ according to an embodiment.

FIG. 3 represents an illustrative diagram of a reactor system to produce ammonia from nitrogen and water, according to an embodiment.

FIG. 4 depicts an X-ray diffraction pattern of BVO₂FeO₂ according to an embodiment. XRD of BVO₂FeO₂ indicates it is a polycrystalline material and was acquired on a Xperts Pananalytical X-Ray diffractometer using Ni-filtered CuKα radiation (λ=0.15418 nm) with scanning range (2θ) of 10 to 90. The peaks 2θ at 25.00, 33.31, 34.80 and 61.40 correspond to vanadium iron oxide, iron borate, iron vanadium oxide and vanadium borate; pcpdf files are—38-1372, 76-0701, 75-0317 and 17-0311; corresponding Millar indices (h k l) values are (1 2 0), (1 0 4), (3 1 1) and (1 0 4).

FIG. 5 shows vibrating sample magnetometer measurements of BVO₂FeO₂ catalyst according to an embodiment.

FIG. 6 shows schematics of the reaction mechanism of water and nitrogen to form ammonia according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

Disclosed herein are methods and systems to produce ammonia from nitrogen and water. In some embodiments, a method of producing ammonia involves contacting nitrogen, water, and at least one superparamagnetic catalyst to form a mixture, and exposing the mixture to a fluctuating magnetic field. The nitrogen may be from any source, such as natural gas, air, flue gas, and the like.

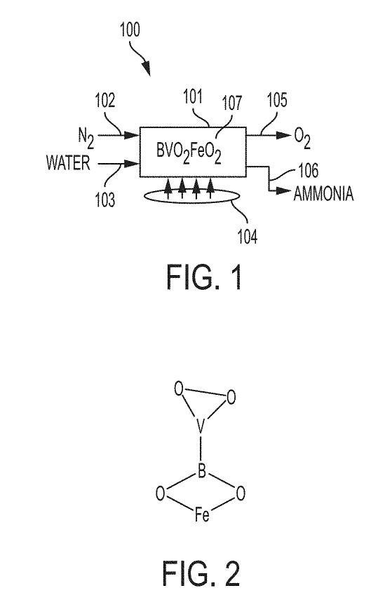

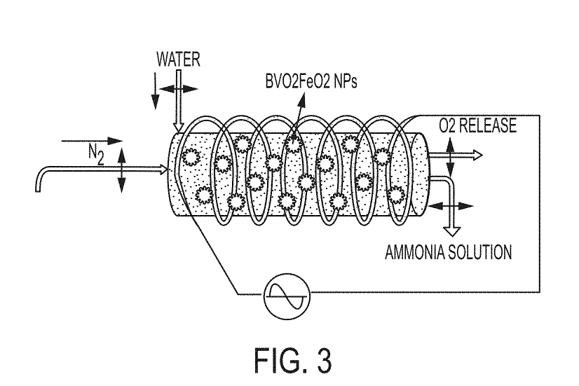

FIG. 1 depicts an illustrative diagram of a reactor system 100 in accordance with a specific embodiment of the present disclosure. System 100 may be utilized for a one-step process for the production of ammonia from nitrogen and water. The reactor system (or apparatus) 100 generally comprises a reaction vessel 101, an inlet valve for nitrogen 102, an inlet valve for water 103, and a current carrying element 104. A pair of outlet valves for O₂ gas 105 and ammonia 106 may be present in the reaction vessel 101. The inlet valves may be configured to allow entry of nitrogen and water into the reaction vessel. Further, the catalyst BVO₂FeO₂ 107 may be disposed within the reaction vessel.

In some embodiments, the reactor system 100 comprises at least one current carrying element 104 arranged in proximity to a surface of the reaction vessel and configured to provide a fluctuating magnetic field. Current carrying elements may include, for example, substrates having conductive or magnetic properties. Further, current carrying elements may be configured to generate magnetic fields of various strengths. The greater the current flow and coil density, the stronger the magnetic field. For instance, coil density may be high in order to produce a uniform magnetic field. In addition, the quantity of power required to achieve a particular magnetic field may depend on various factors, including the scale, structure, and location of the current carrying element with respect to the reaction vessel.

In other embodiments, the reactor system described herein may further include at least one thermoelectric couple, at least one pressure gauge, at least one temperature controller, at least one cooling system, at least one mechanical stirrer, or any combination thereof. In some embodiments, the current carrying element may be in close proximity to the reaction vessel. In other embodiments, the current carrying element may form a circular coil around a reaction vessel, as illustrated in FIG. 1. According to some embodiments, the strength of a magnetic field generated by the current carrying element may have various strengths, such as about 0.1 millitesla to about 1 tesla, about 0.1 millitesla to about 0.5 tesla, about 0.1 millitesla to about 0.1 tesla, about 0.1 millitesla to about 10 millitesla, about 0.1 millitesla to about 1 millitesla, or any range between any two of these values (including endpoints). The current carrying elements may be energized using various methods, including, without limitation, direct current, alternating current, and high-frequency alternating current. According to embodiments, the high-frequency alternating current may have various values, such as about 25 hertz (Hz) to about 1 megahertz, about 25 hertz to about 500 kilohertz, or about 25 hertz to about 100 kilohertz. Specific examples include, but are not limited to, about 25 hertz, about 100 hertz, about 500 hertz, about 1 kilohertz, about 100 kilohertz, about 200 kilohertz, about 300 kilohertz, about 400 kilohertz, about 500 kilohertz, and about 1 megahertz, or any range between any two of these values (including endpoints). In some embodiments, the electric current may have various values, such as about 0.1 ampere (A) to about 100 A, about 0.1 ampere to about 50 A, about 0.1 ampere to about 30 A, or about 0.1 ampere to about 1 A. Specific examples include, but are not limited to, about 0.1 A, about 1 A, about 5 A, about 10 A, about 20 A, about 50 A, and about 100 A, or any range between any two of these values (including endpoints).

The reactor system described herein may be a batch reactor system or a continuous flow reactor system. In some embodiments, the reaction vessel is configured to maintain a substantially constant pressure of nitrogen during the reaction process. For example, nitrogen may be present at various pressures, such as a pressure of about 1 millibar to about 1 bar, about 1 millibar to about 500 millibars, about 1 millibar to about 100 millibars, or about 1 millibar to about 10 millibars. Specific examples include about 1 millibar, about 5 millibars, about 10 millibars, about 15 millibars, about 20 millibars, about 100 millibars, about 200 millibars, about 300 millibars, about 400 millibars, about 500 millibars, and about 1 bar, or any range between any two of these values (including endpoints).

The catalyst 105 that may be used in the reaction system 100 may be a superparamagnetic catalyst, such as BVO₂FeO₂, BVOFe₃O₄, BTiO₂Fe₂O₃, BCrO₂Fe₂O₃, and any combination thereof. In some embodiments, the catalyst may be in the form of nanoparticles. The catalyst described in the embodiments herein may be unsupported or may be supported by distribution over a surface of a support in a manner that maximizes the surface area of the catalytic reaction. A suitable support may be selected from any conventional support, such as polymer membrane or a porous aerogel. For example, the catalyst may be coated on a polymer membrane and woven into a 3D mesh and introduced in the reactor system 100.

In some embodiments, the catalyst described herein may be present in the reaction mixture at various concentrations, such as about 0.1 mole percent to about 1 mole percent, about 0.1 mole percent to about 0.5 mole percent, or about 0.1 mole percent to about 0.2 mole percent of the total reaction mixture. Specific examples include, but are not limited to, about 0.1 mole percent, about 0.2 mole percent, about 0.5 mole percent, about 0.7 mole percent, and about 1 mole percent, or any range between any two of these values (including endpoints).

In some embodiments, the water may be present in the reaction mixture at various concentrations, such as about 99 mole percent to about 99.9 mole percent, about 99 mole percent to about 99.6 mole percent, or about 99 mole percent to about 99.3 mole percent of the total reaction mixture.

In some embodiments, the reaction mixture is exposed to a fluctuating magnetic field for various periods of time, such as about 30 minutes to about 3 hours. In some embodiments, the reaction mixture is exposed to a fluctuating magnetic field for about 30 minutes to about 2 hours. In some embodiments, the fluctuating magnetic field is applied for about 30 minutes to about 1 hour. In some embodiments, the reaction mixture is exposed to the fluctuating magnetic field for about 30 minutes, about 45 minutes, about 1 hour, about 1.5 hours, about 2 hours, about 3 hours, or any value or range of values between any of these values (including endpoints). At the end of the reaction process, the superparamagnetic catalyst may be recovered by applying a magnetic field. For example, a bar magnet may be used to collect BVO₂FeO₂ particles at the end of the reaction and reused.

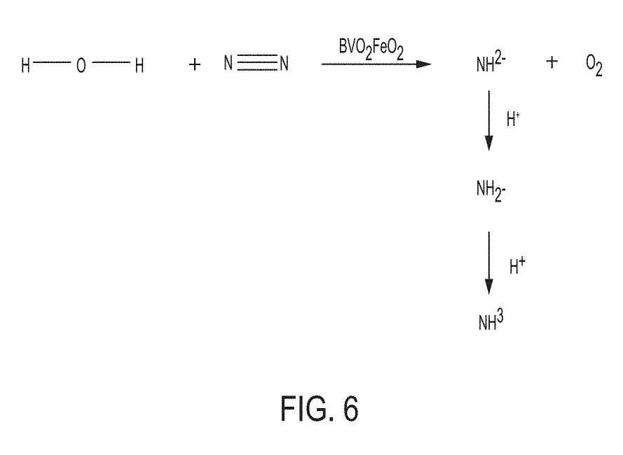

BVO₂FeO₂ may act as a solid-state source of electrons in liquids, enabling a new pathway for induction catalytic reduction in which electrons are directly ejected into reactants. This approach may be particularly advantageous to achieve induction chemical reduction of otherwise difficult-to-reduce species, such as N₂ that bind only weakly to most surfaces, such as V used as a catalyst in the experiments, that combines with the proton generated (H⁺) at the catalytic site. Further, H⁺ and OH⁻ may be generated from water by the same catalyst. The mechanism is illustrated in FIG. 6.

The methods disclosed herein may produce aqueous ammonia. Processes for removal of ammonia from dilute aqueous solutions are well known in the art and may be performed by stripping with an inert gas such as air, nitrogen, or the like and then extracting the ammonia from the gas by absorption in an acidic medium. The gas, after passing through the ammonia absorbing medium is recycled so that the stripping is performed in a closed loop. The stripping may be performed at pH 10.5-11.5 and at 140-180° F. The pH of the aqueous waste may be adjusted by adding caustic soda solution. A commonly used acidic medium for absorption of ammonia from the gas is aqueous sulfuric acid. During absorption the acid solution is recirculated to allow a build-up of ammonium sulfate until a portion of the salt may be crystallized. Mother liquor is then fortified with acid and recycled.

Also disclosed here are methods to prepare a catalyst. In some embodiments, the method involves contacting vanadium pentoxide with a first base to form a first reaction composition, contacting the first reaction composition with boric acid to form a second reaction composition, contacting the second reaction composition with a second base to form a third reaction composition, contacting the third reaction composition with tetramethylethylene diamine (TEMED) to form a fourth reaction composition, and contacting the fourth reaction composition with Fe₂O₃ to form the catalyst. In some embodiments, the catalyst produced herein is a superparamagnetic catalyst.

In some embodiments, vanadium pentoxide is mixed with a first base to form a first reaction composition, and mixing may be performed for various periods of time, such as for about 3 minutes to about 30 minutes, about 3 minutes to about 20 minutes, about 3 minutes to about 15 minutes, or about 3 minutes to about 10 minutes. The first base may generally be any base, such as NaOH, KOH, Mg(OH)₂, Ca(OH)₂, or NH₄OH, or any combination thereof. Mixing may be performed by generally any technique, such as stirring, shaking, sonication, and the like.

In some embodiments, the first reaction composition is mixed with boric acid to form a second reaction composition, and mixing may be performed for various periods of time, such as for about 3 minutes to about 30 minutes, about 3 minutes to about 20 minutes, about 3 minutes to about 15 minutes, or about 3 minutes to about 10 minutes. Mixing may be performed by generally any technique, such as stirring, shaking, sonication, and the like.

In some embodiments, the second reaction composition is mixed with the second base to form a third reaction composition. Non-limiting examples of second base are sodium borohydride, KOH, LiOH, Mg(OH)₂, NH₄OH, and any combination thereof. Mixing may be performed for various periods of time, such as for about 30 minutes to about 60 minutes, about 30 minutes to about 50 minutes, about 30 minutes to about 40 minutes, or about 30 minutes to about 35 minutes. This mixing may be performed at generally any temperature, such as a temperature of about 70° C. to about 120° C., about 70° C. to about 100° C., about 70° C. to about 90° C., or about 70° C. to about 80° C. Mixing may be performed by generally any technique, such as stirring, shaking, sonication, and the like.

The third reaction composition may optionally be cooled to room temperature, and mixed with a bidentate ligand to form a fourth reaction composition. Non-limiting examples of bidentate ligand include acetylacetonate, phenanthroline, an oxalate, tetramethylethylene diamine (TEMED), trimethylene diamine, and any combination thereof. Mixing may be performed for various periods of time, such as for about 2 minutes to about 15 minutes, about 2 minutes to about 10 minutes, about 2 minutes to about 5 minutes, or about 2 minutes to about 3 minutes. In some embodiments, the bidentate ligand may be TEMED, and TEMED solution may be diluted with water to a final concentration of about 1-5% (v/v) and mixed with the third reaction composition.

In some embodiments, the fourth reaction composition is mixed with Fe₂O₃ for various periods of time, such as for about 10 minutes to about 60 minutes, about 10 minutes to about 50 minutes, about 10 minutes to about 40 minutes, or about 10 minutes to about 30 minutes. In some embodiments, the Fe₂O₃ described herein may be dissolved in H₂O₂, such as 10% (v/v) H₂O₂ before mixing with the fourth reaction composition.

After the mixing the fourth reaction composition with Fe₂O₃, the solvent may be removed or evaporated. This step may be performed by generally any known process, such as heating, rotary evaporation, air drying, Soxhlet extraction, reflux condenser, or evaporating in an oven until the solvent is substantially evaporated. For example, the solvent may be heated to an elevated temperature, such as about 80° C., about 100° C., about 120° C., or about 130° C., using a reflux condenser. The reaction process may be outlined as follows:

2Fe₂O₃+2V₂O₅+4H₃BO₃→4BVFeO₄+6H₂O+3O₂

In some embodiments, the BVFeO₄ obtained may be further subjected to the steps of washing, filtering, and drying. Drying may be generally performed in a hot air oven by heating to an elevated temperature, such as a temperature of about 80-120° C. for various periods of time, such as for about 30 minutes to about 60 minutes. After drying, the BVFeO₄ powder may be heated, such as in a furnace, to an elevated temperature, such as a temperature of about 500° C. to about 800° C., for various periods of time, such as for about 5 minutes to about 1 hour, about 5 minutes to about 45 minutes, about 5 minutes to about 30 minutes, or about 5 minutes to about 15 minutes. Specific examples include, but are not limited to, about 5 minutes, about 10 minutes, about 15 minutes, about 30 minutes, about 45 minutes, and about 1 hour, or any ranges between any two of these values (including their endpoints).

In some embodiments, the BVFeO₄ obtained after heating is subjected to ethanol washing in the presence of oxygen. This step converts BVFeO₄ to BVO₂FeO₂. This process may impart a superparamagnetic property to the catalyst.

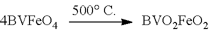

The BVO₂FeO₂ catalyst obtained by the methods disclosed herein may be a nanoparticle having an average diameter, such as an average diameter of about 1 nanometer to about 50 nanometers, about 1 nanometer to about 40 nanometers, about 1 nanometer to about 25 nanometers, or about 1 nanometer to about 10 nanometers. Specific examples include, but are not limited to, about 1 nanometer, about 5 nanometers, about 15 nanometers, about 25 nanometers, and about 50 nanometers, or any range between any two of these values (including their endpoints). A putative structure of BVO₂FeO₂ catalyst is shown in FIG. 2.

### EXAMPLES

### Example 1

### Preparation of the Catalyst BVO₂FeO₂

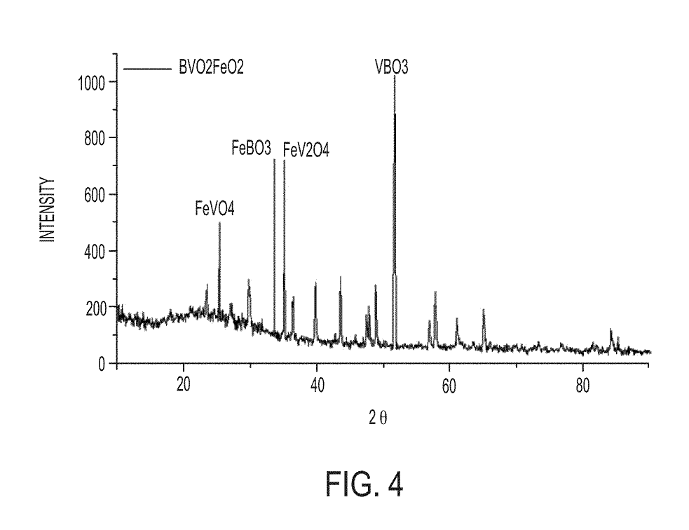

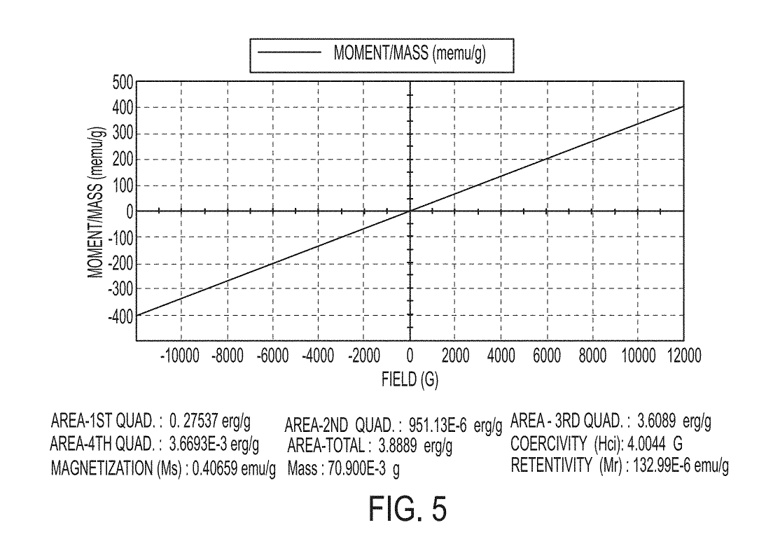

About 2 grams of vanadium pentoxide was dispersed in 50 mL of IN sodium hydroxide in a flat bottom flask and sonicated for 5 cycles (700 watts; 3 minutes per cycle). About 2 grams of boric acid was added to the above mixture and again sonicated for 5 cycles. To this resulting mixture, about 50 mL of 0.1 N sodium borohydride was added slowly and stirred vigorously using a magnetic stirrer for 30-40 minutes at 100° C. After cooling the mixture, about 20 mL of 2% TEMED (2 mL TEMED in 100 mL of deionized water) was added and the mixture was stirred for 5 minutes. To this mixture, about 1 gram of Fe₂O₃ in 10% H₂O₂ was mixed, and the solution was stirred vigorously using a plastic overhead stirrer for 30 minutes. The solution was transferred to a Soxhlet apparatus and maintained at 100° C. until all the excess solvent was evaporated. The residue was washed with distilled water until a pH of 7 was reached. After filtering, the residue powder was dried in a hot air oven at 100° C. for 30 minutes. Finally, the recovered compound was heated in a furnace for 10 minutes at 700° C., removed, and about 10 mL of ethanol was added immediately. The catalyst thus prepared was characterized by X-ray diffraction (FIG. 4) and used for experiments described below.

### Example 2

### Production of Ammonia from Nitrogen and Water

About 500 milligrams of BVO₂FeO₂ catalyst prepared in Example 1 was dispersed in 50 mL of water in three neck flask, connected to N₂ cylinder and a gas collection chamber. The flask was subjected to fluctuating magnetic field by supplying an electric current of 230V, 50 Hz, 210 mA for 60 minutes (magnetic field about 1000 μtesla). Ammonia obtained was confirmed by NMR. The BVO₂FeO₂ catalyst was recovered using simple magnets (0.03T) for reuse.

### Example 3

### Production of Ammonia from Nitrogen and Water

The apparatus was set up as described in Example 2 and various parameters were changed to analyze the effect on the yield of ammonia. Table 1 shows the yield of ammonia obtained in response to various amounts of catalyst used. The volume of water (50 mL), exposure time (60 minutes), and the chamber pressure (1.2 bar of nitrogen) were kept constant in all the experiments.

TABLE 1

| | Time of | | Volume | Ammonia/ | | |
|---|---|---|---|---|---|---|
| | exposure | Catalyst | of water | water yield | Remaining | Ammonia |
| S. No | (min.) | (mg.) | (mL) | (in mL) | solution | yield(%) |
| 1 | 60 | 100 | 50 | 9.5/27.8 ± 0.3 | 37.3 ± 0.4 | 25.33 |
| 2 | 60 | 200 | 50 | 14.55/20.8 ± 0.3 | 35.4 ± 0.3 | 40.84 |
| 3 | 60 | 300 | 50 | 19.15/13.1 ± 0.3 | 32.3 ± 0.2 | 59.5 |
| 4 | 60 | 400 | 50 | 20.75/7.5 ± 0.3 | 28.3 ± 0.2 | 73.4 |
| 5 | 60 | 500 | 50 | 23.45/2.1 ± 0.3 | 25.6 ± 0.3 | 91.76 |

The process was repeated and the time of exposure to fluctuating magnetic field was varied. The volume of water (50 mL), catalyst (500 milligrams), and the chamber pressure (1.2 bar of nitrogen) were kept constant throughout the process. The percent yields of ammonia are shown in Table 2.

TABLE 2

| | Time of | | Volume | Ammonia/ | | |
|---|---|---|---|---|---|---|
| | exposure | Catalyst | of water | water yield | Remaining | Ammonia |
| S. No | (min.) | (mg.) | (mL) | (in mL) | solution | yield(%) |
| 1 | 30 | 500 | 50 | 15.35/19.65 ± 0.3 | 35 ± 0.2 | 43.71 |
| 2 | 60 | 500 | 50 | 23.45/2.05 ± 0.3 | 25.5 ± 0.2 | 91.76 |
| 3 | 90 | 500 | 50 | 24.15/1.25 ± 0.3 | 25.4 ± 0.2 | 94.88 |
| 4 | 120 | 500 | 50 | 24.15/0.85 ± 0.3 | 25 ± 0.2 | 96.4 |

Further, the process was repeated and the chamber pressure was varied. The volume of water (50 mL), catalyst (500 milligrams), and exposure time to fluctuating magnetic field (60 minutes) were kept constant throughout the process. The percent yields of ammonia are shown in Table 3.

TABLE 3

| | Chamber | | | |
|---|---|---|---|---|
| | pressure | Ammonia/water | Remaining | Ammonia |
| S. No | (bar) | yield (in mL) | solution | yield(%) |
| 1 | 1.02 | 11.15/20.3 ± 0.3 | 35.1 ± 0.3 | 31.62 |
| 2 | 1.05 | 13.65/19 ± 0.3 | 32.7 ± 0.15 | 41.59 |
| 3 | 1.10 | 16.45/13.7 ± 0.3 | 30.2 ± 0.2 | 54.3 |
| 4 | 1.15 | 20.15/9.3 ± 0.3 | 29.5 ± 0.2 | 68.15 |
| 5 | 1.20 | 23.45/2 ± 0.3 | 25.5 ± 0.3 | 91.76 |

These studies demonstrated that higher catalyst loading, increased exposure time to fluctuating magnetic field, and higher chamber pressure increased ammonia yield.

### Example 4

### Analysis of Energy Consumption During Production of Ammonia from Nitrogen and Water

The energy consumption to produce ammonia (91% yield) was measured by varying the amount of catalyst and keeping other parameters, such as chamber pressure (1.2 bar), water volume (50 mL), and magnetic field strength (1000 microtesla) constant.

TABLE 4

| | | | power | power |
|---|---|---|---|---|
| | catalyst | exposure time | required for | consumption |
| | weight | for 91% yield | 1 kilogram | (MWh) per |
| S. No | (milligram) | (minutes) | of NH₃ | ton |
| 1 | 100 | 217 | 39.4 | 39.4 |
| 2 | 200 | 134 | 24 | 24 |
| 3 | 300 | 92 | 16.8 | 16.8 |
| 4 | 400 | 75 | 13.6 | 13.6 |
| 5 | 500 | 60 | 10.8 | 10.8 |

The energy consumption to produce ammonia (91% yield) was also measured by varying the reaction chamber volume and keeping other parameters, such as chamber pressure (1.2 bar), water volume (50 mL), catalyst amount (500 milligrams), and magnetic field strength (1000 microtesla) constant.

TABLE 5

| | reaction | | power | power |
|---|---|---|---|---|
| | chamber | exposure time | required for | consumption |
| | volume | for 91% yield | 1 kilogram | (MWh) per |
| S. No | (mL) | (minutes) | of NH₃ | ton |
| 1 | 250 | 60 | 10.8 | 10.8 |
| 2 | 500 | 40 | 7.25 | 7.25 |
| 3 | 1000 | 25 | 4.5 | 4.5 |

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (example, bodies of the appended claims) are generally intended as “open” terms (example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (example, the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (example, “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (example, “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A method of producing ammonia, the method comprising:
contacting nitrogen, water, and at least one superparamagnetic catalyst to form a mixture; and
exposing the mixture to a fluctuating magnetic field to produce ammonia.

2. The method of claim 1, wherein contacting nitrogen, water, and at least one superparamagnetic catalyst comprises contacting nitrogen, water, and BVO₂FeO_{2.}

3. The method of claim 1, wherein exposing the mixture to the fluctuating magnetic field to produce ammonia comprises exposing the mixture to the fluctuating magnetic field to produce aqueous ammonia.

4. The method of claim 1, wherein exposing the mixture to the fluctuating magnetic field comprises exposing the mixture to the fluctuating magnetic field in a closed reaction vessel.

5. The method of claim 1, wherein exposing the mixture to the fluctuating magnetic field comprises exposing the mixture to the fluctuating magnetic field in a closed reaction vessel having at least one inlet and at least one outlet.

6. The method of claim 4, further comprising maintaining a substantially constant pressure of nitrogen in the closed reaction vessel.

7. The method of claim 6, wherein exposing the mixture to the fluctuating magnetic field comprises maintaining nitrogen in the closed reaction vessel at a pressure of about 1 millibar to about 1 bar.

8. The method of claim 1, wherein contacting nitrogen, water, and at least one superparamagnetic catalyst to form the mixture comprises contacting nitrogen and water with the superparamagnetic catalyst which is present at about 0.1 mole percent to about 1 mole percent of the mixture.

9. The method of claim 1, wherein contacting nitrogen, water, and at least one superparamagnetic catalyst comprises contacting nitrogen, water, and BVO₂FeO₂ nanoparticles.

10. The method of claim 9, wherein contacting nitrogen, water, and at least one superparamagnetic catalyst comprises contacting nitrogen, water, and BVO₂FeO₂ nanoparticles coated on a polymer membrane.

11. The method of claim 1, wherein exposing the mixture to the fluctuating magnetic field comprises exposing the mixture to the fluctuating electromagnetic field generated by an electrical current of about 0.1 ampere (A) to about 100 A, and having a frequency of about 25 hertz to about 1 megahertz.

12. The method of claim 11, wherein exposing the mixture to the fluctuating magnetic field comprises exposing the mixture to the fluctuating electromagnetic field of about 0.1 millitesla to about 1 tesla.

13. The method of claim 1, wherein exposing the mixture to the fluctuating magnetic field comprises exposing the mixture to the fluctuating magnetic field for about 30 minutes to about 3 hours.

14. The method of claim 1, further comprising performing the contacting and exposing steps as a batch process or a continuous process.

15.-28. (canceled)

29. A reactor system for producing ammonia from nitrogen, the reactor comprising:
a closed reaction vessel configured to receive nitrogen, water, and a superparamagnetic catalyst; and
at least one current carrying element arranged in proximity to a surface of the reaction vessel and configured to provide a fluctuating magnetic field.

30. The reactor system of claim 29, wherein the catalyst is BVO₂FeO₂ nanoparticles.

31. (canceled)

32. The reactor system of claim 29, wherein the reactor system is a batch reactor system or a continuous reactor system.

33. The reactor system of claim 29, further comprising at least one inlet valve and at least one outlet valve.

34. (canceled)

35. The reactor system of claim 29, wherein the reaction vessel is configured to maintain a constant pressure of nitrogen during a reaction process.

36. The reactor system of claim 29, further comprising a thermoelectric couple, a pressure gauge, a temperature controller, a cooling system, a mechanical stirrer, or any combination thereof.

37.-39. (canceled)
